(19) United States
(12) Patent Application Publication
(10) Pub. No.: US 2006/0133483 A1
(43) Pub. Date: Jun. 22, 2006

(54) Method for encoding and decoding video signal

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/293,134

(22) Filed: Dec. 5, 2005

Related U.S. Application Data
(60) Provisional application No. 60/632,995, filed on Dec. 6, 2004.

(30) Foreign Application Priority Data
Jul. 29, 2005 (KR) 10-2005-0069810

(51) Int. Cl. H04N 7/12; H04N 11/02; H04B 1/66; H04N 11/04

(52) U.S. Cl. 375/240.08; 375/240.25

(57) ABSTRACT

Disclosed is a method for scalably encoding and decoding a video signal. An enhanced layer having a higher spatial resolution is predicted and encoded based on an enhanced layer having a relatively lower spatial resolution. Then, the encoded enhanced layer is decoded, thereby improving a coding efficiency.

### DOMESTIC PRIORITY INFORMATION

This application claims priority under 35 U.S.C. §119 on U.S. provisional application 60/632,995, filed Dec. 6, 2004; the entire contents of which are hereby incorporated by reference.

### FOREIGN PRIORITY INFORMATION

This application claims priority under 35 U.S.C. §119 on Korean Application No. 10-2005-0069810, filed Jul. 29, 2005; the entire contents of which are hereby incorporated by reference.

### BACKGROUND OF THE INVENTION

1. Field of the invention

The present invention relates to a method for encoding and decoding a video signal, and more particularly to a method for encoding video data by predicting an enhanced layer based on another enhanced layer having a relatively lower spatial resolution, and decoding video data encoded by the above scheme.

2. Description of the Prior Art

It is difficult to allocate a broadband available for TV signals to wirelessly transmitted/received digital video signals wirelessly transmitted/received from/in a portable phone and a notebook computer, which have been extensively used, and a mobile TV and a hand held PC, which are expected to be extensively used in the future. Accordingly, a standard to be used for a video compression scheme for such portable devices must enable a video signal to be compressed with a relatively high efficiency.

In addition, such portable mobile devices are equipped with various processing and presentation capabilities. Accordingly, compressed videos must be variously prepared corresponding to the capabilities of the portable devices. Therefore, the portable devices must be equipped with video data having various qualities obtained through the combination of various parameters including the number of transmission frames per second, resolution, and the number of bits per pixel with respect to one video source, burdening content providers.

For this reason, the content provider prepares compressed video data having a high bit rate with respect to one video source so as to provide the portable devices with the video data by decoding the compressed video and then encoding the decoded video into video data suitable for a video processing capability of the portable devices requesting the video data. However, since the above-described procedure necessarily requires trans-coding (decoding+scaling+encoding), the procedure causes a time delay when providing the video requested by the portable devices. In addition, the trans-coding requires complex hardware devices and algorithms due to the variety of a target encoding.

In order to overcome these disadvantages, there is suggested a Scalable Video Codec (SVC) scheme. According to the SVC scheme, a video signal is encoded with a best video quality in such a manner that the video quality can be ensured even though parts of the overall picture sequences (frame sequences intermittently selected from among the overall picture sequences) derived from the encoding are decoded.

Scalability is a new concept introduced by MPEG-2 in order to increase immunity against error and adaptability to bit rates. According to the scalability, a base layer having a lower-resolution or smaller-size screen and an enhanced layer (or enhancement layer) having a higher-resolution or larger-size screen are included. The base layer refers to a bit stream encoded to be independently decoded. The enhanced layer refers generally to a bit stream used to improve the bit stream of the base layer, for example, a bit stream obtained by more-finely encoding a differential value between the original data and an encoded data of the base layer. The scalability includes spatial scalability, temporal scalability and SNR scalability.

The spatial scalability is a scheme for increasing the size or resolution of a picture having a small size or low resolution. According to the spatial scalability, screens are divided into base layers having a low spatial resolution and enhanced layers having a high spatial resolution, the base layers are firstly encoded, and then the enhanced layers are encoded using corresponding base layers, for example, a differential component between the enhanced layer and an interpolation component of corresponding base layers may be encoded. Then, two encoded bit streams are together transmitted.

The temporal scalability is a scheme for increasing a temporal resolution by adding enhanced layers to base layers. For instance, the temporal scalability may convert video of 15 frames per second into video of 30 frames per second.

The SNR scalability is a scheme for improving image quality. According to the SNR scalability, transform coefficients (e.g., Discrete Cosine Transform (DCT) coefficients) corresponding to pixels are classified into base layers and enhanced layers depending on resolutions for bit presentation.

FIG. 1 is a block diagram illustrating the configuration of a scalable video codec, to which the temporal, spatial and SNR (or quality) scalabilities are applied, using a ‘2D+t’ configuration.

A single video source may be encoded to plural layers having different resolutions, that is, a video signal (enhanced layer-2) of 4 times the common intermediate format (4CIF) corresponding to an original resolution (the size of an original screen), a video signal (enhanced layer-1) of CIF corresponding to half of the original resolution, and a video signal (based layer) of quarter CIF (QCIF) corresponding to a quarter of the original resolution, based on the same scheme or different schemes. The following description will be given for a case in which each of the layers is independently encoded by a motion compensated temporal filter (MCTF).

In comparing among the resolutions or sizes of screens, when the resolutions or sizes of screens are calculated, based on the entire number of pixels or based on the area of the entire pixels under a condition that the pixels are arranged at an equal interval in the right and left direction, the size/resolution of the 4CIF is four times as large/high as that of the CIF and is sixteen times as large/high as that of the QCIF. However, when the above calculation is performed based on the number of pixels arranged in the longitudinal or lateral direction, the size/resolution of the 4CIF is two times as large/high as that of the CIF and is four times as large/high as that of the QCIF. In the following description, the sizes or resolutions of screens will be compared not based on the entire number or size of pixels but based on the number of pixels arranged in the longitudinal or lateral direction, so the resolution (size) of the CIF is a half of that of the 4CIF and is two times as large/high as that of the CIF.

Layers having different resolutions are obtained by encoding the same content in different spatial resolutions or in different frame rates, so that redundancy information exists in data streams encoded for the layers. Therefore, in order to increase the coding efficiency of a first (e.g., an enhanced layer), the video signal of the first layer is predicted by using the data stream encoded for a second layer (e.g., a base layer) having a lower resolution than the first layer, which is called an ‘inter-layer prediction method’. Through the inter-layer prediction method, the spatial scalability can be applied to a video codec. The inter-layer prediction method and the MCTF are combined to encode a video signal, thereby generating a data stream having spatial/temporal scalability.

Meanwhile, progressive refinement, successive refinement and fine grained scalability (FGS), which are detailed schemes for realizing the SNR scalability, are generally used as the same meaning as the SNR scalability. The method of encoding a video signal into an SNR base layer and an SNR enhanced layer having SNR scalability will now be described.

First, data (e.g., data of a macro block, a frame, a slice or a block) generated by encoding a video signal may be converted into DCT transform coefficients and then quantized. In this case, in the quantizing procedure, the transform coefficients are quantized based on a step size predetermined corresponding to a predetermined quality (or a predetermined bit rate), quantization coefficients generated by which forms an SNR base layer.

The quantizing procedure enables the transform coefficients to be expressed by a finite number of representative values based on a step size for quantization, thereby obtaining a higher compression efficiency. Although it is possible to obtain a very high compression efficiency through the quantizing procedure, once quantized values cannot be restored to their original video signals, so that video is lost when the video is reconstituted.

In order to compensate for a loss (error) occurring in the encoding procedure (DCT and quantization procedure), a DCT and quantization procedure is performed with respect to a difference between data of an original macro block and data of a macro block, which is restored through an inverse quantization and inverse DCT procedure for the SNR base layer, thereby generating the first level of the SNR enhanced layer. In this case, the step size in the process of the quantization procedure for the difference is set to have quality one-step higher than the predetermined quality (or bit rate) corresponding to the SNR base layer, because the quantization procedure for the difference is performed with respect to the differential value between the original macro block and the restored macro block. Since an amount of data in the differential value is significantly smaller than that of the original macro block, the step size in the above quantization procedure for the differential value is set smaller than that of the quantization procedure for the SNR base layer.

The procedure for performing the DCT with respect to differential values between the original macro block and a restored macro block and for quantizing the transformed data based on a step size for quantization determined by the above-mentioned scheme are repeated, thereby sequentially generating plural levels (SNR_EL_{—}1, SNR_EL_{—}2, . . . , SNR_EL_N) of SNR enhanced layer capable of compensating for an error occurring in the encoding procedure such as the DCT and quantization procedure. Each level of the SNR enhanced layer may be configured with information of one bit or more depending on step sizes for quantization. Generally, however, since each level of the SNR enhanced layer is obtained while gradually reducing the size of the quantization step by a half per each step, each level of the SNR enhanced layer is constructed with 1-bit information.

It is assumed that, when a transform coefficient is expressed in 8 bits, the SNR base layer includes information of 5 bits, and each of the first, second and third levels (SNR_EL_{—}1, SNR_EL_{—}2 and SNR_EL_{—}3) of the SNR enhanced layer includes information of 1 bit, from among the 8-bit transform coefficient. In this case, information corresponding to upper 5 bits (digits 2⁷ through 2³) of the transform coefficient fills in the SNR base layer, and information corresponding to the remaining 3 bits (digits 2² through 2⁰) of the transform coefficient sequentially fills in the SNR enhanced layer. That is, information corresponding to the 2² digit fills in the first level of the SNR enhanced layer, information corresponding to the 2¹ digit fills in the second level of the SNR enhanced layer, and information corresponding to the 2⁰ digit fills in the third level of the SNR enhanced layer. When the transform coefficient generated as described above is transmitted, the SNR base layer is first transmitted, and then the first, second and third levels of the SNR enhanced layer are transmitted in regular sequence. In this case, information of each layer or level may be provided with a fixed or variable number of bits. In all cases, meaningless information may fill in the remaining digits, except for digits in which information to be transmitted fills.

Next, a method for scalably decoding the SNR base layer and SNR enhanced layer into the original video data (block data) will be described.

The SNR base layer and SNR enhanced layer may be sequentially transmitted in real time or recorded in a recording medium. In the former case, only a part of the SNR enhanced layer may be decoded together with the SNR base layer, depending on transmission environments (transmission speeds) of transmission media. In the latter case, either a part or all levels of the SNR enhanced layer recorded in the recording medium may be decoded together with the SNR base layer, depending on reproduction environments.

The SNR base layer is restored to a base block (B_BL) having video data through inverse quantization and inverse DCT. Data of the block (B_BL) restored from the SNR base layer represents a rougher video than the original video data.

Next, the first level of the SNR enhanced layer is restored to a first enhanced block (B_EL_{—}1) through inverse quantization and inverse DCT, and added to the base block (B_BL) restored from the SNR base layer, thereby enabling the base block (B_BL) to be represented in detail.

After this, the other levels (SNR_EL_{—}2, . . . , SNR_EL_N) of the SNR enhanced layer are sequentially restored to second, . . . , N^{th} enhanced blocks (B_EL_{—}2, . . . , B_EL_N) through inverse quantization and inverse DCT, and added to the base block (B_BL) and first enhanced block (B_EL_{—}1), thereby enabling the resultant block to have video data closer and closer to the original video data.

FIG. 2 is a view for illustrating the SNR base layer and SNR enhanced layer generated through the above-mentioned method with respect to videos having different spatial resolutions.

An SNR scalable coding for a block (or frame) having a QCIF spatial resolution generates an SNR base layer (QCIF_BL) and N levels (QCIF_EL_{—}1˜QCIF_EL_N) of SNR enhanced layer. An SNR base layer and an SNR enhanced layer having N levels are also created with respect to each of blocks having spatial resolutions of CIF and 4CIF.

When a QCIF block has a size of 4×4, its corresponding CIF block has a size of 8×8 and its corresponding 4CIF block has a size of 16×16. Through an SNR scalable coding (e.g., through DCT and quantization), a 4×4 SNR base layer and a 4×4 SNR enhanced layer having N levels consisting of DCT transform coefficients are created for a QCIF 4×4 block.

The resolutions in bit presentation for the SNR base layer and SNR enhanced layer are determined as differential values depending on target presentation qualities and transmission environments. For example, as shown in FIG. 2, when a transform coefficient has a size of 8 bits, the SNR base layer may be constructed with information of 5 bits, and each of the first, second and third levels of the SNR enhanced layer may be constructed with information of 1 bit. In the above case, it is also possible that the SNR base layer is constructed with information of 4 bits, and each of the first and second levels of the SNR enhanced layer is constructed with information of 2 bits. In addition, it is possible that the SNR base layer is constructed with information of 5 bits, the first level of the SNR enhanced layer is constructed with information of 2 bits, and the second level of the SNR enhanced layer is constructed with information of 1 bit.

For instance, in the case in which each transform coefficient in a 4×4 SNR base layer configured with DCT transform coefficients for a 4×4 block having a QCIF resolution contains information of 5 bits, when transform coefficient values are stacked in series from the most significant bit (MSB), which is the 2⁷ digit, to the 2³ digit while forming each floor with the bit values of the same digit, a 4×4 plane configured with ‘0’ and ‘1’ is formed for each digit as shown in FIG. 2. This plane is defined as a ‘transform coefficient bit plane’. Therefore, with respect to a 4×4 SNR base layer containing information of 5 bits of a transform coefficient, five 4×4 transform coefficient bit planes are formed. In addition, with respect to each of the first, second and third levels of the SNR enhanced layer, a 4×4 transform coefficient bit plane may be formed. Similarly, with respect to an SNR base layer and an SNR enhanced layer for an 8×8 block, eight 8×8 transform coefficient bit planes may be formed.

As described above, the inter-layer prediction method for predicting a video signal of a layer having a high spatial resolution by using a video signal of a layer having a low spatial resolution has been used to increase a coding efficiency for layers having a high spatial resolution. However, such an inter-layer prediction method used for layers having different spatial resolutions has been applied to only video signals before the DCT and quantization procedure but has not been applied to data generated through the DCT and quantization procedure.

### SUMMARY OF THE INVENTION

Accordingly, the present invention has been made to solve the above-mentioned problems occurring in the prior art, and an object of the present invention is to provide a method for encoding an SNR layer having a first spatial resolution by using an SNR layer having a second spatial resolution different from the first spatial resolution in order to improve a coding efficiency, and a method for decoding a video signal encoded through the encoding method.

In order to accomplish this object, there is provided a method for encoding a video signal, the method comprising the steps of: generating a second bit stream by encoding a video signal in a predetermined scheme; and generating a first bit stream by scalably encoding the video signal, wherein each of the first and second bit streams includes a first layer and a second layer for compensating for an error occurring in an encoding procedure, and at least a part of the second layer of the first bit stream is predicted by using prediction data generated based on the second layer of the second bit stream.

Herein, at least a part of the second layer is predicted in a bit plane unit, and is a part of plural levels included in the second layer.

Also, the step of generating the first bit stream further comprises a step of recording information, which represents that a predetermined level is predicted and encoded based on the second layer of the second bit stream, in a header area of the predetermined level of the second layer of the first bit steam predicted based on the second layer of the second bit stream.

In addition, the step of generating the first bit stream further comprises a step of recording information, which represents that the second layer of the first bit stream is predicted and encoded based on the second layer of the second bit stream, in a header area of the second layer of the first bit steam predicted when all levels of the second layer of the first bit steam are predicted based on the second layer of the second bit stream.

A bit plane of the first bit stream is divided to a size of a bit plane of the second bit stream, and prediction data for each of the divided bit planes is generated based on the corresponding bit plane of the second bit stream. Also, prediction data for a bit plane of the first bit stream is generated based on a corresponding bit plane of a second bit stream which has been enlarged to a size of the bit plane of the first bit stream. In this case, the prediction data for the bit plane is generated by an XOR operation on two bit planes.

Preferably, the method further comprises a step of transmitting prediction data for the second layer through the first bit stream and the second bit stream by turns in a sequence from a lower level to a higher level.

In accordance with another aspect of the present invention, there is provided a method for decoding an encoded video bit stream, the method comprising the steps of: decoding a first bit stream of received bit streams, which have been scalably encoded and include a plurality of vide sequences; and decoding a second bit stream of the video bit steams, wherein each of the first and second bit streams includes a first layer and a second layer for compensating for an error occurring in an encoding procedure, and at least a part of the second layer of the first bit stream is decoded based on the second layer of the second bit stream.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the configuration of a scalable video codec having a ‘2D+t’ configuration;

FIG. 2 is a view for illustrating SNR base layers and SNR enhanced layers for each video having different spatial resolutions;

FIG. 3 is a view for explaining a method for predicting an SNR enhanced layer in a bit plane unit by using another SNR enhanced layer having a lower spatial resolution according to an embodiment of the present invention;

FIG. 4 is a view for explaining a method for transmitting an SNR base layer and each SNR enhanced layer, which have spatial resolutions different from each other, or extracting the layers from a bit stream according to an embodiment of the present invention; and

FIGS. 5A and 5B are views for explaining an extraction sequence for an SNR base layer and levels of an SNR enhanced layer, which have spatial resolutions different from each other, between the present invention and the prior art.

### DETAILED DESCRIPTION OF EXAMPLE EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

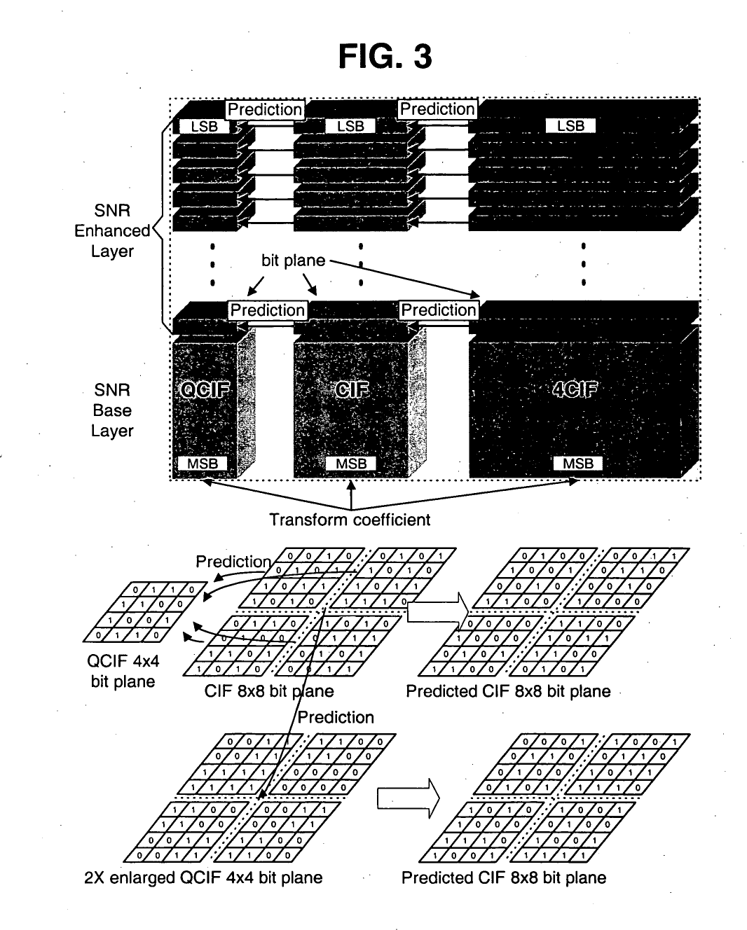

FIG. 3 is a view for explaining a method for predicting a predetermined SNR enhanced layer in a bit plane unit by using another SNR enhanced layer having a lower spatial resolution than the predetermined SNR enhanced layer according to an embodiment of the present invention.

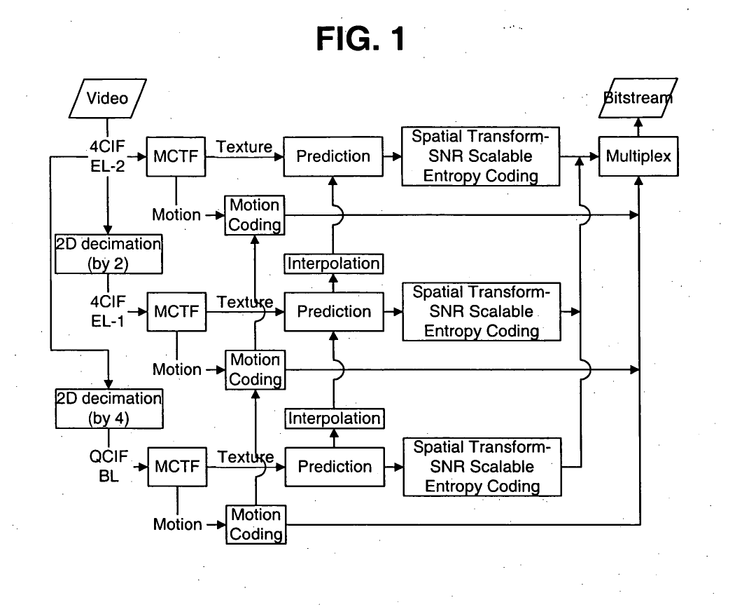

As shown in FIG. 1, a single video source is divided into video signals of plural layers having different spatial resolutions, that is, into a 4CIF video signal having the original resolution, a CIF video signal having a half of the original resolution and a QCIF video signal having a quarter of the original resolution. Then, the divided video signals are independently encoded by a predetermined scheme, for example, by MPEG-2, MPEG-4, H.264, MCTF or the like.

After this, each video data (e.g., block or frame data) having different spatial resolutions is transformed into a DCT transform coefficient and quantized, thereby being an SNR base layer for a corresponding spatial resolution. In addition, DCT and quantization are repeatedly performed for differential values between the original block and a restored block, so that an SNR enhanced layer having plural levels are generated for each corresponding spatial resolution.

That is, a block (or frame) having the QCIF spatial resolution is transformed into an SNR base layer and an SNR enhanced layer having N levels, which are configured with transform coefficients quantized by the SNR scalable coding. Also, with respect to each of the blocks having spatial resolutions of CIF and 4CIF, an SNR base layer and an SNR enhanced layer having N levels configured with quantized transform coefficients are generated.

In this case, each quantized transform coefficient of a video block includes information consisting of a predetermined number of bits, for example, 5 bits for a base layer and 3 bits for an enhanced layer, and bit planes having predetermined sizes (e.g., 4×4 for QCIF, 8×8 for CIF and 16×16 for 4CIF) are generated corresponding to the predetermined number of bits of the information.

After this, with respect to a CIF 8×8 bit plane of a predetermined level in an SNR enhanced layer for a CIF 8×8 block, prediction data are created based on a QCIF 4×4 bit plane of the predetermined level in an SNR enhanced layer for a QCIF 4×4 block corresponding to the CIF 8×8 block.

As shown in FIG. 3, the CIF 8×8 bit plane is divided into four CIF 4×4 bit planes, each of which is compared with the QCIF 4×4 bit plane. With respect to two 4×4 bit planes compared each other, if the values (0 or 1) of two compared pixels are equal, the value of a corresponding pixel is determined as ‘0’, and if not, the value of a corresponding pixel is determined as ‘1’. That is, a predicted CIF 4×4 bit plane is created through an XOR operation of the values of corresponding two pixels, and four predicted CIF 4×4 bit planes created using four divided CIF 4×4 bit planes are combined to generate one predicted CIF 8×8 bit plane.

On the other hand, as shown in FIG. 3, the CIF 8×8 bit plane may be compared with a 2× enlarged QCIF 8×8 bit plane, which has been created by enlarging the QCIF 4×4 bit plane to an 8×8 bit plane, to generate a predicted CIF 8×8 bit plane.

With respect to each level of the CIF SNR enhanced layer, when coding the data of a predicted bit plane is better than coding the original bit plane, a corresponding level of the CIF SNR enhanced layer is encoded using the data of the predicted bit plane. Then, a bit plane prediction flag, which represents that a corresponding level of the CIF SNR enhanced layer has been predicted and generated in a bit plane unit on the basis of a corresponding level of a QCIF SNR enhanced layer, is set to, e.g., “1” to fill in a header area of the corresponding level of the CIF SNR enhanced layer.

Similarly to the above-mentioned CIF, in the case of the 4CIF 16×16 bit plane of a predetermined level in an SNR enhanced layer for a 4CIF 16×16 block, prediction data are created based on a CIF 8×8 bit plane of the predetermined level in an SNR enhanced layer for a CIF 8×8 block corresponding to the 4CIF 16×16 block.

Then, when coding the data of a predicted bit plane is better, the bit plane prediction flag is set to “1” to be recorded in a header area of a corresponding level of the 4CIF SNR enhanced layer.

Also, with respect to a level of the SNR enhanced layer configured with more than one bit, a level of the SNR enhanced layer is divided into bit planes as many as the number of bits and can be predicted based on a corresponding level of an SNR enhanced layer having a lower spatial resolution.

Meanwhile, the bit plane prediction flag may be set without distinguishing the levels of the SNR enhanced layer and recorded in the header area of the SNR enhanced layer. In this case, whether cording the data of a predicted SNR enhanced layer is better or cording the data of the original SNR enhanced layer is better is judged on the basis of all levels of the SNR enhanced layer.

Also, The bit plane prediction flag may be set in each block unit.

A data stream of the SNR base layer and SNR enhanced layer of each resolution encoded by the above-mentioned method is transmitted to a decoding apparatus by wire or wireless, or is transferred by a recording medium. The method for restoring the original video signal by the decoding apparatus restores will now be described. The decoding apparatus may be contained in a mobile terminal or in a recording medium reproduction apparatus.

An SNR base layer and an SNR enhanced layer are configured with quantized transform coefficients. A 4×4 block of a QCIF SNR base/enhanced layer corresponds to an 8×8 block of a CIF SNR base/enhanced layer, and also to a 16×16 block of a 4CIF SNR base/enhanced layer.

It is assumed that a bit plane prediction flag is set in a block unit, in which the bit plane prediction flag represents whether or not SNR base and SNR enhanced layers are coded to predicted data on the basis of bit planes included in different SNR base and SNR enhanced layers having a relatively lower spatial resolution.

When a bit plane prediction flag included in a header area of a block contained in a predetermined level of an SNR enhanced layer is set to “0”, it is determined that the corresponding block has been configured with the original quantized transform coefficients. In contrast, when the bit plane prediction flag is set to “1”, it is determined that the corresponding block has been configured with data predicted on the basis of a bit plane of the corresponding block in the predetermined level of an SNR enhanced layer having a low spatial resolution.

The decoding apparatus checks the value of a bit plane prediction flag recorded in the header area of an 8×8 block in a predetermined level of a CIF SNR enhanced layer. As a result of the checking, when the bit plane prediction flag is set to “1”, the decoding apparatus divides an 8×8 bit plane (predicted bit plane) of the predetermined level of the CIF SNR enhanced layer to four 4×4 prediction bit planes. Then, with respect to each of the four divided CIF 4×4 prediction bit planes, the decoding apparatus generates the original CIF 4×4 bit plane on the basis of a QCIF 4×4 bit plane in the predetermined level of a QCIF SNR enhanced layer which corresponds to the CIF 8×8 block, and combines the generated original 4×4 bit planes, thereby obtaining the original CIF 8×8 bit plane. Next, the original CIF 8×8 bit planes obtained as described above are combined, thereby forming each level of the original CIF SNR enhanced layer configured with the original quantized transform coefficients. The original CIF 4×4 bit plane can be easily created by performing an XOR operation on the divided CIF 4×4 prediction bit plane and the QCIF 4×4 bit plane.

In addition, the decoding apparatus may generate a 2× enlarged QCIF 8×8 bit plane by enlarging a QCIF 4×4 bit plane in the predetermined level of a QCIF SNR enhanced layer corresponding to the CIF 8×8 block to an 8×8 bit plane, and then generates the original CIF 8×8 bit plane by using the generated 2× enlarged QCIF 8×8 bit plane.

When the bit plane prediction flag is set for each level of an SNR enhanced layer, each level of the SNR enhanced layer configured with the original quantized transform coefficients can be obtained by performing the above-mentioned operation for each level of the SNR enhanced layer.

After this, the decoding apparatus restores a QCIF base block (or frame) having video data by performing inverse quantization and inverse DCT operations for the original QCIF SNR base layer, restores a QCIF enhanced block (or frame) having video data by performing inverse quantization and inverse DCT operations also for each level of the original QCIF SNR enhanced layer in regular sequence, and adds the restored QCIF enhanced layer to the restored QCIF base layer, thereby obtaining a block (or frame) containing data closer and closer to the original video data.

Similarly, with respect to also a 4CIF SNR enhanced layer, the decoding apparatus obtains the original 4CIF SNR enhanced layer on the basis of a bit plane of a CIF SNR enhanced layer, and performs the inverse quantization and inverse DCT operations for each level of the obtained 4CIF SNR enhanced layer in regular sequence, thereby restoring a block closer and closer to the original video data.

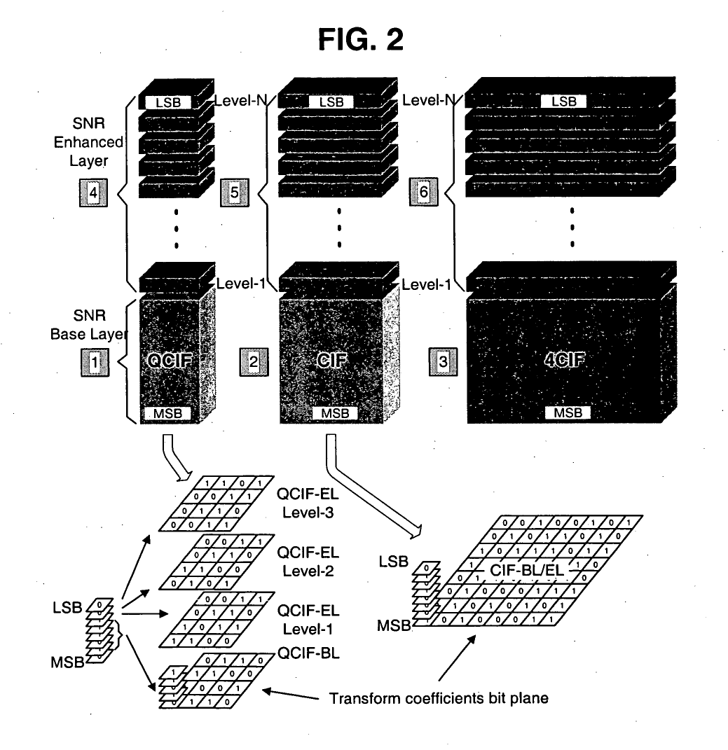

Meanwhile, according to the prior art, SNR enhanced layers having different resolutions have no relationship therebetween. Therefore, as shown in FIGS. 2 and 5A, after QCIF, CIF and 4CIF SNR base layers are transmitted or extracted, all levels of a QCIF SNR enhanced layer, all levels of a CIF SNR enhanced layer and all levels of a 4CIF SNR enhanced layer are sequentially transmitted or extracted from a transmitted bit stream or a bit stream recorded in a recording medium.

However, according to the present invention, an SNR enhanced layer having a CIF or 4CIF resolution is encoded to data predicted on the basis of a bit plane of an SNR enhanced layer having a QCIF or CIF resolution, which is a relatively lower spatial resolution. In this case, in order to restore video data (i.e., data of quantized transform coefficients) of a CIF or 4CIF block (or frame), the SNR enhanced layer having the QCIF or CIF resolution, which is a relatively lower spatial resolution, is required as a basis for prediction data. Also, the inverse quantization and inverse DCT operations are performed for a base layer, a first level of an enhanced layer, a second level of the enhanced layer, . . . , and an Nth level of the enhanced layer in regular sequence.

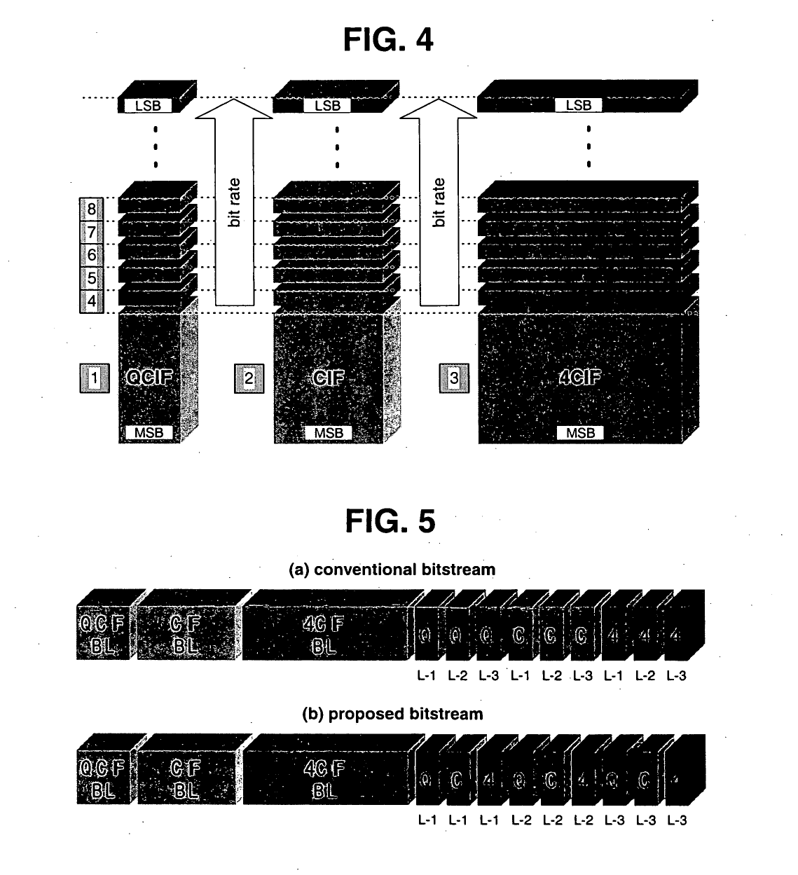

Therefore, in order to sequentially perform inverse prediction, inverse quantization and inverse DCT operations, which are performed to restore data of quantized transform coefficients from data predicted in a bit plane unit, for each level of the SNR enhanced layer having a CIF or 4CIF resolution, SNR base layers having QCIF, CIF and 4CIF resolutions are extracted, and then first levels of SNR enhanced layers having the QCIF, CIF and 4CIF resolutions second levels of the SNR enhanced layers, . . . , and Nth levels of the SNR enhanced layers must be sequentially transmitted or extracted from a transmitted bit stream or a bit stream recorded in a recording medium, as shown in FIGS. 4 and 5B.

Meanwhile, according to the sequence as shown in FIG. 5A, after sequentially extracting all levels of SNR enhanced layers having the lowest spatial resolution (QCIF), all levels of the SNR enhanced layers having the second-lowest spatial resolution (CIF), and all levels of the SNR enhanced layers having the highest spatial resolution (4CIF), the decoding apparatus stores them in a memory. Then, the decoding apparatus may sequentially perform the inverse prediction, inverse quantization and inverse DCT operations for each level of the SNR enhanced layers having a higher spatial resolution, on the basis of each level of the SNR enhanced layer having a relatively lower spatial resolution.

However, for instance, since not only a first level (QCIF_EL_{—}1) of a QCIF SNR enhanced layer which is a basis but also all the other levels (QCIF_EL_{—}2˜QCIF_EL_N) of the QCIF SNR enhanced layer must be extracted and stored in order to perform an inverse prediction operation for a first level (CIF_EL_{—}1) of a CIF SNR enhanced layer, a required amount of memory is large, and the interval between the CIF_EL_{—}1 and the QCIF_EL_{—}1 stored in the memory lengthens.

Therefore, as shown in FIG. 5B, it is more efficient that a bit stream is transmitted in a sequence of QCIF_BL, CIF_BL, 4CIF_BL, QCIF_EL_{—}1, CIF_EL_{—}1, 4CIF_EL_{—}1, QCIF_EL_{—}2, CIF_EL_{—}2, 4CIF_EL_{—}2, . . . , or that the layers and levels are extracted in the same sequence from a transmitted bit stream or a bit stream recorded in a recording medium.

As described above, according to the present invention, quantized transform coefficients of an SNR enhanced layer are predicted and encoded on the basis of a bit plane of an SNR enhanced layer having a different spatial resolution, thereby improving its coding efficiency.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for encoding a video signal, the method comprising the steps of:
generating a second bit stream by encoding a video signal in a predetermined scheme; and
generating a first bit stream by scalably encoding the video signal,
wherein each of the first and second bit streams includes a first layer and a second layer for compensating for an error occurring in an encoding procedure, and at least a part of the second layer of the first bit stream is predicted by using prediction data generated based on the second layer of the second bit stream.

2. The method as claimed in claim 1, wherein at least a part of the second layer is predicted in a bit plane unit.

3. The method as claimed in claim 2, wherein at least a part of the second layer is a part of plural levels included in the second layer.

4. The method as claimed in claim 3, wherein the step of generating the first bit stream further comprises a step of recording information, which represents that a predetermined level is predicted and encoded based on the second layer of the second bit stream, in a header area of the predetermined level of the second layer of the first bit steam predicted based on the second layer of the second bit stream.

5. The method as claimed in claim 3, wherein the step of generating the first bit stream further comprises a step of recording information, which represents that the second layer of the first bit stream is predicted and encoded based on the second layer of the second bit stream, in a header area of the second layer of the first bit steam predicted when all levels of the second layer of the first bit steam are predicted based on the second layer of the second bit stream.

6. The method as claimed in claim 2, wherein a bit plane of the first bit stream is divided to a size of a bit plane of the second bit stream, and prediction data for each of the divided bit planes is generated based on the corresponding bit plane of the second bit stream.

7. The method as claimed in claim 2, wherein prediction data for a bit plane of the first bit stream is generated based on a corresponding bit plane of a second bit stream which has been enlarged to a size of the bit plane of the first bit stream.

8. The method as claimed in claim 6, wherein prediction data for a bit plane is generated by an XOR operation on two bit planes.

9. The method as claimed in claim 1, further comprising a step of transmitting prediction data for the second layer through the first bit stream and the second bit stream by turns in a sequence from a lower level to a higher level.

10. A method for decoding an encoded video bit stream, the method comprising the steps of:
decoding a first bit stream of received bit streams, which have been scalably encoded and include a plurality of vide sequences; and
decoding a second bit stream of the video bit steams,
wherein each of the first and second bit streams includes a first layer and a second layer for compensating for an error occurring in an encoding procedure, and at least a part of the second layer of the first bit stream is decoded based on the second layer of the second bit stream.

11. The method as claimed in claim 10, wherein at least a part of the second layer is decoded in a bit plane unit.

12. The method as claimed in claim 11, wherein at least a part of the second layer is a part of plural levels included in the second layer.

13. The method as claimed in claim 12, wherein the step of decoding the first bit stream further comprises a step of determining whether each level of the second layer of the first bit stream has been encoded based on the second layer of the second bit stream, by checking a header area of each corresponding level.

14. The method as claimed in claim 12, wherein the step of decoding the first bit stream further comprises a step of determining whether all levels of the second layer of the first bit stream have been encoded based on the second layer of the second bit stream, by checking a header area of the second layer of the first bit stream.

15. The method as claimed in claim 10, wherein a bit plane of the first bit stream is divided to a size of a bit plane of the second bit stream, and original data of each of the divided bit planes is generated based on a corresponding bit plane of the second bit stream.

16. The method as claimed in claim 10, wherein original data of a bit plane of the first bit stream is generated based on a corresponding bit plane of a second bit stream which has been enlarged to a size of the bit plane of the first bit stream.

17. The method as claimed in claim 15, wherein original data of a bit plane is generated by an XOR operation on two bit planes.

18. The method as claimed in claim 10, wherein, when the second layer is extracted from bit streams having plural video sequences received therein, the second layer is extracted through the first and second bit streams by turns in a sequence from a lower level to a higher level.

19. The method as claimed in claim 7, wherein prediction data for a bit plane is generated by an XOR operation on two bit planes.

20. The method as claimed in claim 16, wherein original data of a bit plane is generated by an XOR operation on two bit planes.
